(19) United States
(12) Patent Application Publication
(10) Pub. No.: US 2005/0086228 A1
(43) Pub. Date: Apr. 21, 2005

(54) Conditionalized Access Control Based on Dynamic Content Analysis

(75) Inventors: Thomas R. Gross, Zurich (CH); Guenter Karjoth, Waedenswil (CH); Matthias Schunter, Zurich (CH)

Correspondence Address: INTERNATIONAL BUSINESS MACHINES CORPORATION;INTELLECTUAL PROPERTY LAW, 650 HARRY ROAD, SAN JOSE, CA, 95120, US

(73) Assignee: INTERNATIONAL BUSINESS MACHINES CORPORATION, Armonk, NY (US)

(21) Appl. No.: 10/904,038

(22) Filed: Oct. 20, 2004

(30) Foreign Application Priority Data
Oct. 20, 2003 (EP) 03405756.2

(51) Int. Cl. G06F 17/30

(52) U.S. Cl. 707/9

(57) ABSTRACT

According to the present invention, there is provided a method and apparatus for controlling an access for a client application residing on a user computer to data stored on a network computer within a network. The method comprises the steps of receiving a request from the user computer for accessing the data; retrieving the data from the network computer and storing it in a memory; deriving from the stored data at least one attribute that relates to the content of the data; and deciding based on the derived at least one attribute whether or not the data stored in the memory is provided to the user computer

### FIELD OF THE INVENTION

The present invention is related to a method and apparatus for controlling an access for a client application residing on a user computer to data stored on a network computer within a network.

### BACKGROUND OF THE INVENTION

Access control usually is part of the middleware and defines whether a user may access a resource by means of an access control policy. This policy is usually defined by an administrator who defines access rights for each pair of user and resource, which are also referred to as access decision information (ADI). This approach can be augmented by allowing boolean conditions that evaluate attributes.

Known proposals present an abstract manner of retrieving resource or object ADI with a so-called attribute function AF that is provided by the application itself, e.g., as proposed by Konstantin Beznosov, “Object Security Attributes: Enabling Application-specific Access Control in Middleware,” presented at the 4th International Symposium on Distributed Objects & Applications (DOA), pp. 693-710, Irvine, Calif., Oct. 28-Nov. 1, 2002.

The known proposals present the attribute function as part of the application, which has the disadvantage that it is outside of the scope of the administration of the access control system in the middleware, that means the function is within the application space. Further, the proposals refer to an attribute function as an abstract concept only.

In common systems only the attributes of a user, that is the accessing party, are considered by the addressed access control system. The system decides then whether or not a recourse is accessible for the user based on the mentioned user attributes. This static process, for example, provides the user with read or write rights.

Known are also systems which use a filter for their access control. However, a filter based system is rather fixed and therefore a reconfiguration is costly.

From the above it follows that there is still a need in the art for an improved access control which is capable of retrieving access decision information from the content or resource of pages or files at the application layer. Moreover, a working protocol flow for the attribute retrieval of HyperText Markup Language (HTML) pages and other parsable data should be provided.

### SUMMARY OF THE INVENTION

In accordance with the present invention, there is provided a method for controlling an access for a client application residing on a user computer to data stored on a network computer within a network. The method comprises the steps of receiving a request from the user computer for accessing the data; retrieving the data from the network computer and storing it in a memory; deriving from the stored data at least one attribute that relates to the content of the data; and deciding based on the derived at least one attribute whether or not the data stored in the memory is provided to the user computer.

In accordance with a second aspect of the present invention, there is provided an apparatus for controlling an access for a client application residing on a user computer to data stored on a network computer within a network. The apparatus comprises an access control unit for retrieving the data on request by the user computer from the network computer and storing the data in a memory; a content analysis unit connected to the access control unit for deriving from the stored data at least one attribute that relates to the content of the data; and a rules engine that decides based on the derived at least one attribute whether or not the data stored in the memory is provided to the user computer. The rules engine is part of the access control unit. The attribute can be combined with the attributes from other attribute functions.

An access control system can comprise the apparatus or perform the method. The system may form an access control product.

In general, the method and apparatus allow to dynamically retrieve application-specific access control information from pages, files, or other resource information which can be parsed. In other words, the accessed pages of files can be pre-fetched and parsed at the application layer to obtain access decision information, also abbreviated as ADI. Based on the retrieved content of the pages or files, the access control system can then dynamically decide whether access shall be granted or not. An attribute function can be provided that is located in the middleware and capable of retrieving the access decision information from the content or resource pages of the application layer. The decision step takes advantage of the attribute function.

The decision step can further comprise the step of granting or denying access to the stored data in the memory. This allows to control the access of the user computer to the stored data, i.e. to the requested data.

Moreover, the decision step can comprise the step of deriving from a provided attribute name and the content of the stored data an attribute result that is usable to decide whether or not the stored data is allowed to be accessed.

Further, the access control can be based on short-term states of the content of the data.

The step of deriving the attribute result can comprise analyzing meta information of the stored data. Meta information is contemplated as data related information which may be stored in the header or somewhere within a file or page, e.g. an HTML page announces those information with “meta”. This allows an owner or editor of an HTML page to classify said page application specific or according to the owner or editor's principles.

The meta information can specify a workflow state, for example, whether a document is in a “draft” or “final” state. When the workflow state of a page comprises ‘draft’, the page might be not accessible. Further, the meta information can specify a confidentiality state, e.g. any external (public) access to pages containing “Confidential” can be blocked automatically. According to the state, the users have or have not respective access rights.

The meta information can further specify a topic of the data, i.e. a topic can be assigned to the data or the page content. For instance, only users responsible for a topic is allowed to access pages that are tagged with this topic. In a further example the meta information comprises a definition of a work group, thus the access control system grants access to specific work group members assigned by the document owner.

### BRIEF DESCRIPTION OF THE DRAWINGS

FIG. 1 shows a schematic illustration of an access control system with a user computer and a server within a network.

FIG. 2 shows a schematic illustration of the system and server site in more detail.

FIG. 3 shows a schematic illustration of the information flow between a client application of the user computer, the access control system, and the backend server.

FIG. 4 shows a schematic illustration of further information flow.

### DETAILED DESCRIPTION

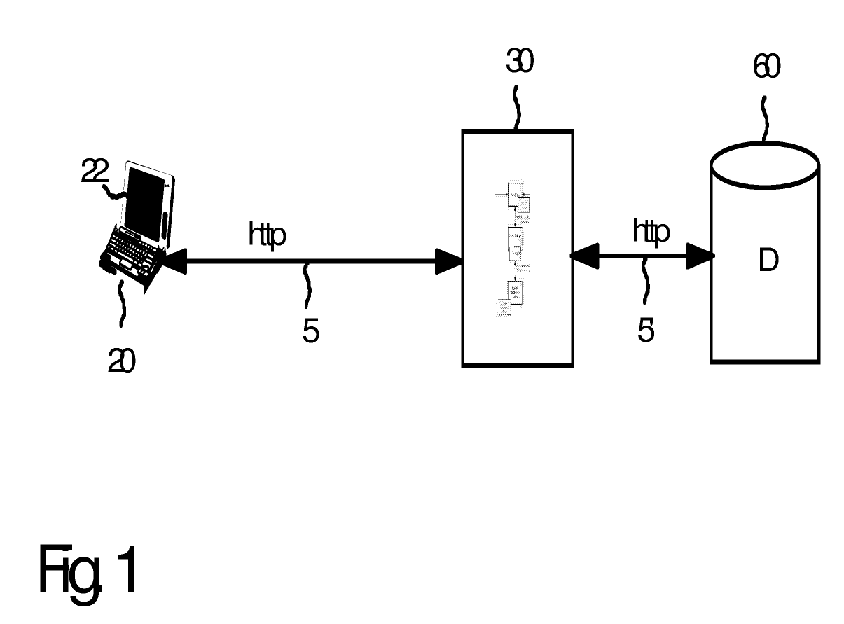

With reference to FIG. 1, the general layout of a communication environment is described in which the invention can be used. In the figures, same reference signs are used to denote the same or like parts.

FIG. 1 shows a schematic illustration of an access control system 30 between a user computer 20 and a network computer 60, also referred to as backend server 60, within a network. The user computer 20 executes a client application 22, e.g. a web browser, a web services client, a shopping agent, a financial-services tool, or any other application that may represent a user. The client application 22 is typically executed on the user computer 20, but may also be executed on another computer as long as one can assume that it acts faithfully for its user. In some cases, the client application 22 may even act as an independent entity with an identity of its own and without the user. The user computer's client application is connected to the access control system 30 e.g. a server of a company providing access control for data. The access control system 30 is further connected to a backend server 60 providing data, also labeled with “D”. The user computer 20 and the access control system 30 are connected via first communication lines 5, and further the access control system 30 and the backend server 60 are connected via second communication lines 5′. The communication lines 5 and 5′ are known in the art and are usually provided through a global network, e.g. the Internet, and a local network, e.g. Intranet or a company internal trust domain, respectively, using an HTTP (HyperText Transfer Protocol) for the information transport.

In the following the general flow for an attribute retrieval of an HTML (HyperText Markup Language) page or resource “D”, also referred as data or document “D”, is described, where the HTML content is pre-fetched and analyzed the following way:

The backend server 60 storing the HTML resource “D” is protected by a Boolean condition of the access control system 30. This condition can specify an access decision information, also shortened as ADI, that shall be applied. If the ADI is associated with the resource “D”, a dedicated component of the access control system 30 can pre-fetch the HTML resource “D”. It can then parse the HTML resource “D” using an analysis scheme in order to retrieve the desired ADI. This ADI is then used to evaluate the Boolean condition that defines whether the HTML resource “D” can be accessed or not.

A step-wise description reads as follows: A user wants to access a resource, i.e. the HTML resource “D” on the backend server 60. The HTML resource “D” is protected by an access control list of the access control system 30 which comprises a Boolean condition that evaluates the ADI. The access control system 30 pre-fetches the HTML resource “D” from the backend server 60 and caches it. Then, the access control system 30 parses the HTML resource “D” to obtain the desired ADI and further evaluates the Boolean condition using the obtained ADI. Finally, the access control system 30 grants or denies access to the cached resource. In a further embodiment the ADI can be retrieved by analyzing so-called HTML META Tags, i.e. meta information, within the HTML content of the HTML resource “D” in order to retrieve the access control information.

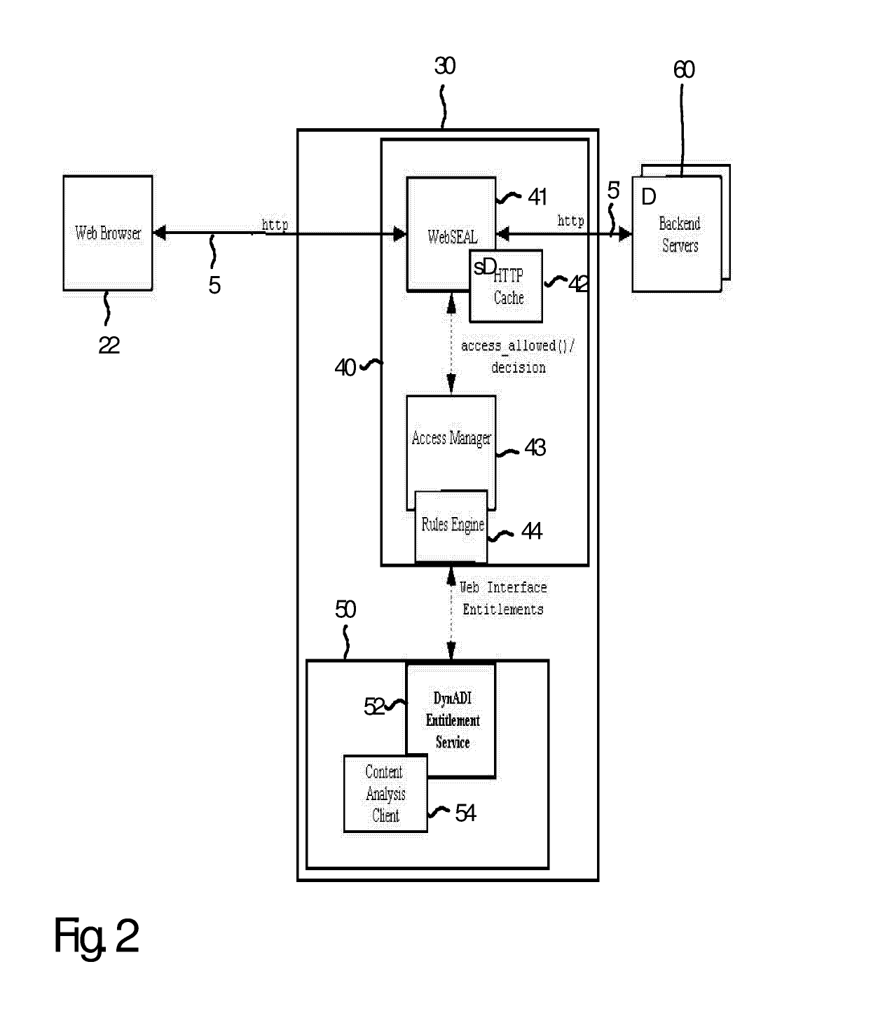

FIG. 2 illustrates the system and server site in more detail. The client application 22 is in this embodiment a web browser 22 that is connected via HTTP to the site of the access control system 30. The access control system 30 comprises here an access control unit 40 and a content analysis unit 50 connected to the access control unit 40. The access control unit 40 comprises a WebSEAL unit 41, an HTTP cache 42, also referred to as memory 42, an access manager unit 43, and a rules engine 44. The content analysis unit 50 comprises a Dyn ADI entitlement service unit 52 and a content analysis unit 54, which form a framework for retrieving arbitrary ADI dynamically. The Dyn ADI entitlement service unit 52 is always entitled to access the resource, i.e. the resource of the data “D” on the backend server 60, although the web browser 22 might not be entitled.

In operation, the access control unit 40 retrieves the data “D”, also referred to as document “D”, on request by the user computer 20 from the backend server 60 and stores the data “D” in the memory 42. The content analysis unit 54 derives then from the stored data, also labeled with “sD” within the memory 42, at least one attribute that relates to the content of the data. The attribute can also be combined with attributes from other attribute functions. The rules engine 44 decides based on the derived at least one attribute whether or not the data stored “sD” in the memory 42 is provided to the user computer 20.

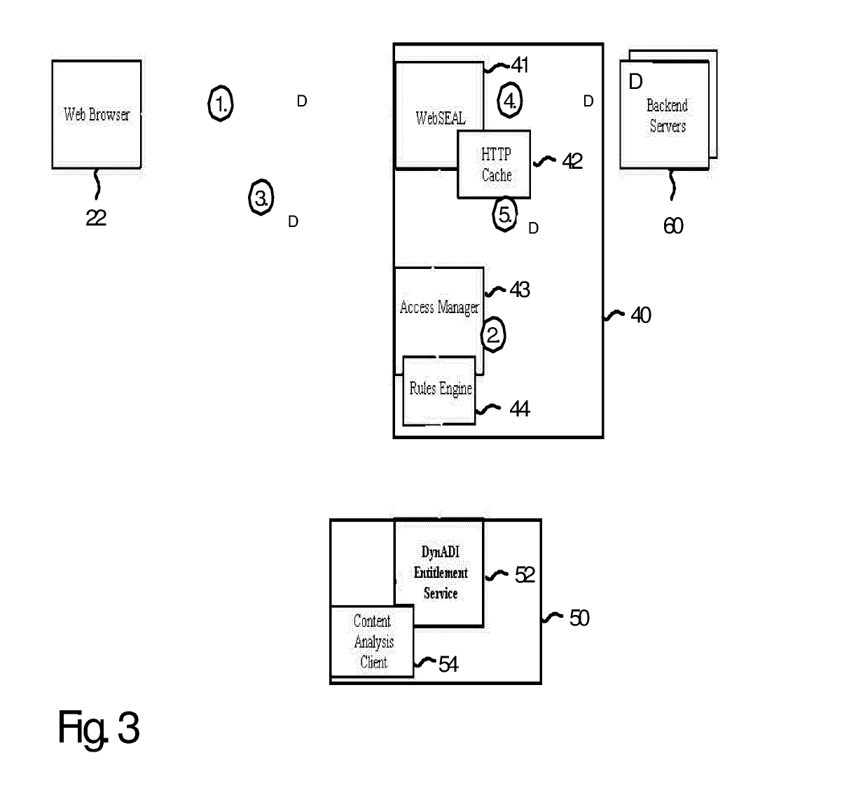

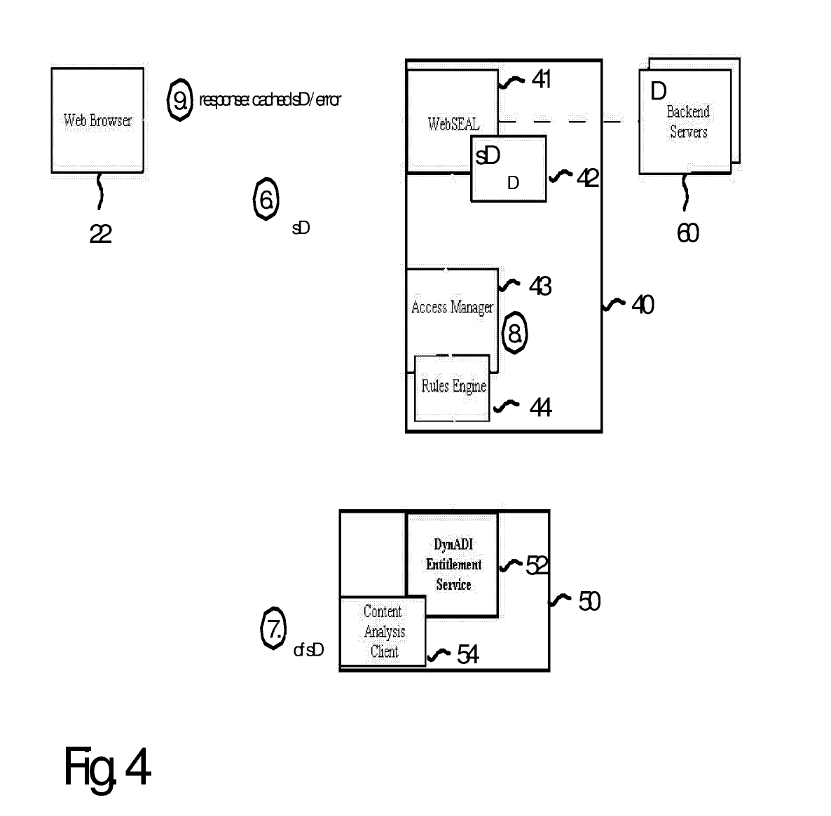

FIGS. 3 and 4 illustrate the information flow in mode detail. For the understanding of the flow, the steps are labeled at the respective arrows or places with numbers in a circle which correspond to the numbers 1.-9. mentioned hereafter. As indicated with 1., the user computer 20 sends from the web browser 22 a “request: D” indicating ‘get document D’ to the access control unit 40, in particular to the WebSEAL unit 41. The WebSEAL unit 41 simulates a browser to the backend server 60 whereas for the web browser 22 the WebSEAL unit 41 looks like a server. The access control unit 40 realizes based on a database that the document “D” is protected. The database comprises respective rules. Further, the access control unit 40 notices the rule to get document “D”. The rules engine 44 is called via the access manager unit 43 in order to interpret the rule. The rules engine 44 interprets the rule and determines whether or not information for an attribute name is available. It is assumed that the rule engine 44 detects an attribute name that is, e.g., “in draft” to which no information is present.

As indicated with 2., the rules engine 44 of the access control unit 40 calls the content analysis unit 50, in particular the Dyn ADI entitlement service unit 52, for values for the attribute name “in draft”. The Dyn ADI entitlement service unit 52 provides the attribute name “in draft” to the content analysis client 54.

As indicated with 3., the content analysis client 54 calls with “retrieve D” the access control unit 40 and requests document “D”.

As indicated with 4., the access control unit 40 sends the request “retrieve D” to the backend server 60 requesting document “D”.

The backend server 60 responses to the access control unit 40 and provides the requested document “D” that is then stored as stored data, also abbreviated as sD, in the memory or cache 42. This is indicated with 5. “cache D”.

As further illustrated with 6. in FIG. 4 with “retrieved sD”, the retrieved document as stored data or document “sD” is then provided to the content analysis unit 50 with the content analysis client 54 and the Dyn ADI entitlement service unit 52.

As indicated with 7. and “analysis of sD”, the content analysis client 54 performs the content analysis by, for example, analyzing meta information or data related information that is contained in the document, i.e. the stored document “sD”. The content of the meta information is here compared with part of the attribute type. An attribute result specifies whether or not the attribute name is contained in the meta information or data related information.

As indicated with 8., the Dyn ADI entitlement service unit 52 of the content analysis unit 50 provides then the rule engine 44 with an attribute that comprises here the attribute name “in draft” and the attribute result “true” that was detected in the content analysis. In general, the rules engine 42 is awaiting the attribute result as “true” or “false”. Then, the rules engine 44 controlled by the access manager unit 43 decides based on the received attribute result “false” that access is granted.

As indicated with 9. and “response: cached sD”, the document “D” in its cached version from the cache 32 is then provided to the web browser 22. In case the decision is based on the attribute result “true” the stored document “sD” is not released and an error message is sent instead to the user computer 20, e.g., “response: error”.

Any disclosed embodiment may be combined with one or several of the other embodiments shown and/or described. This is also possible for one or more features of the embodiments.

The present invention can be realized in hardware, software, or a combination of hardware and software. Any kind of computer system—or other apparatus adapted for carrying out the method described herein—is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which - when loaded in a computer system—is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

1. A method for controlling an access for a client application residing on a user computer to data stored on a network computer within a network, the method comprising: receiving a request from the user computer for accessing the data; retrieving the data from the network computer and storing it in a memory; deriving from the stored data at least one attribute that relates to the content of the data; and deciding based on the derived at least one attribute whether or not the data stored in the memory is provided to the user computer.

2. The method of claim 1 wherein deciding further comprises using an attribute function in the middleware.

3. The method of claim 1 wherein deciding further comprises granting or denying access to the stored data in the memory.

4. The method of claim 1 wherein deriving further comprises: deriving from a provided attribute name and the content of the stored data, an attribute result that is usable to decide whether or not the stored data is allowed to be accessed.

5. The method of claim 4 wherein deriving the attribute result comprises analyzing meta information of the stored data .

6. The method of claim 5 wherein the meta information specifies a workflow state.

7. The method of claim 5 wherein the meta information specifies a confidentiality state.

8. The method of claim 5 wherein the meta information specifies a topic of the data.

9. A computer program product having instruction codes for controlling an access for a client application residing on a user computer to data stored on a network computer within a network, comprising: a set of instruction codes for receiving a request from the user computer for accessing the data; a set of instruction codes for retrieving the data from the network computer and storing it in a memory; a set of instruction codes for deriving from the stored data, at least one attribute that relates to the content of the data;
and a set of instruction codes for deciding based on the derived at least one attribute whether or not the data stored in the memory is provided to the user computer.

10. The computer program product of claim 9 wherein deciding further comprises using an attribute function in the middleware.

11. The computer program product of claim 9 wherein deciding further comprises granting or denying access to the stored data in the memory.

12. The computer program product of claim 9 wherein deriving further comprises: a set of instruction codes for deriving from a provided attribute name and the content of the stored data, an attribute result that is usable to decide whether or not the stored data is allowed to be accessed.

13. The computer program product of claim 12 wherein deriving the attribute result comprises analyzing meta information of the stored data.

14. The computer program product of claim 13 wherein the meta information specifies a workflow state.

15. The computer program product of claim 13 wherein the meta information specifies a confidentiality state.

16. The computer program product of claim 13 wherein the meta information specifies a topic of the data.

17. An apparatus for controlling an access for a client application residing on a user computer to data stored on a network computer within a network, comprising: an access control unit for retrieving the data on request by the user computer from the network computer and storing the data in a memory; a content analysis unit connected to the access control unit for deriving from the stored data at least one attribute that relates to the content of the data; and a rules engine that decides based on the derived at least one attribute whether or not the data stored in the memory is provided to the user computer, the rules engine being part of the access control unit.
